(19) United States
(12) Patent Application Publication
(10) Pub. No.: US 2010/0288381 A1
(43) Pub. Date: Nov. 18, 2010

(54) METHOD AND APPARATUS FOR MIXING FLUIDS

(75) Inventors: ANDREAS DURR, Weil der Stadt (DE); UWE RISSMANN, Wendlingen (DE); Uwe Rissmann, Wendlingen (DE)

Correspondence Address: LAW OFFICE OF DELIO & PETERSON, LLC., 121 WHITNEY AVENUE, NEW HAVEN, CT, 06510, US

(73) Assignee: LEWA GMBH, Leonberg (DE)

(21) Appl. No.: 12/775,162

(22) Filed: May 6, 2010

(30) Foreign Application Priority Data
May 8, 2009 (DE) 10 2009 020 412.1

(51) Int. Cl. F17D 3/00

(52) U.S. Cl. 137/565.01

(57) ABSTRACT

At least two fluids separated from one another are mixed by means of pump force via respective suction lines and conveyed into a conveying line by a pump delivery stroke. The fluids are mixed in the pump head of a single oscillating positive displacement pump, the drive of which is controlled in accordance with a proportion of the fluids to be mixed, the suction stroke of the drive is divided over its rotary angle into individual sections during which the fluids are sucked into the pump head one after another, whereupon the fluids which have already been mixed in the pump head are ejected into the conveying line during the subsequent pump delivery stroke. The suction lines of at least two fluids to be mixed are provided with valves and connected to the pump head, the drive controller of which is configured for switching over the valves.

### CROSS REFERENCE TO RELATED APPLICATION

This application claims priority under 35 U.S.C. § 119 to German patent application DE 10 2009 020 412.1, filed May 8, 2009, the disclosure of which is incorporated herein by reference.

### BACKGROUND OF THE INVENTION

1. Field of the Invention

The invention relates to a method for mixing fluids and an apparatus for performing the same. Specifically, the invention relates to a method and an apparatus for mixing at least two fluids separated from one another and subjected to a pump force via a respective suction line, and conveyed into a conveying line by a pump delivery stroke.

2. Description of Related Art

Fluids may be gaseous and/or liquid, there frequently being the requirement to mix one fluid with the other fluid reliably.

For this purpose, the operation is usually carried out in such a way that in each case two fluids which are separated from one another are sucked in by means of pump force via in each case one suction line and are conveyed into a conveying line by means of a pump delivery stroke.

Each fluid is assigned a dedicated delivery pump which is connected on the suction side to the relevant fluid via in each case one suction line, whereas the delivery line of each pump is connected to a common conveying line.

In the known method, the fluids are accordingly mixed on the delivery side of the pumps, namely when the pump delivery lines open into the common conveying line.

Although, in a known method of this type for mixing fluids, certainly satisfactory mixing results can be achieved in the conveying line, there is nevertheless the disadvantage that the structural outlay for this is not inconsiderable. This is the case, in particular, when more than two fluids are to be mixed with one another, since a dedicated delivery pump is required for each additional fluid.

### SUMMARY OF THE INVENTION

Bearing in mind the problems and deficiencies of the prior art, it is therefore an object of the present invention to provide a method for mixing at least two fluids which are separated from one another being sucked in by means of pump force via in each case one suction line and being conveyed into a conveying line.

The invention is based on the object of configuring the method of the generic type to eliminate the described disadvantages in such a way that it can be carried out more economically and with a more reliable mixing result.

Moreover, an apparatus for carrying out this method is to be provided which has a lower structural outlay.

This object is achieved with the invention by way of the apparatus and method features of the claims. Advantageous refinements of this are described in the further claims.

Still other objects and advantages of the invention will in part be obvious and will in part be apparent from the specification.

The above and other objects, which will be apparent to those skilled in the art, are achieved in the present invention which is directed to a method for mixing at least two fluids separated from one another and subjected to a pump force via a respective suction line, and conveyed into a conveying line by a pump delivery stroke, the method comprising: controlling a single oscillating positive displacement pump's drive in accordance with a proportion of the at least two fluids to be mixed, including: dividing the pump's suction stroke of the drive over the pump's rotary angle into individual sections during which the at least two fluids are sucked into the pump head one after another via the respective suction lines; mixing the at least two fluids in the pump head of the single oscillating positive displacement pump; and ejecting the mixed fluids into the conveying line during the pump delivery stroke.

The step of controlling the single oscillating positive displacement pump drive in accordance with a proportion of the at least two fluids to be mixed may include acting on valves in the respective suction lines of the at least two fluids to be mixed, such that at the beginning of the pump suction stroke, a valve in the respective suction line of a first fluid is opened and the first fluid is sucked into the pump head, and whereupon, when a predefined rotary angle is reached, the valve of the respective suction line of the first fluid is closed and a valve of at least one further respective suction line is opened and at least one further fluid is sucked into the pump head.

The method may further include calculating a division of the rotary angle of the pump drive according to a mixing ratio of the at least two fluids.

In a second aspect, the present invention is directed to an apparatus for mixing at least two fluids separated from one another and subjected to a pump force via a respective suction line, and conveyed into a conveying line by a pump delivery stroke, the apparatus comprising: a single oscillating positive displacement pump; respective suction lines for each of the at least two fluids to be mixed, the respective suction lines connected to the single oscillating positive displacement pump head; individual valves for each of the respective suction lines; and a drive controller configured for switching over the valves.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a schematic diagram of the apparatus of the present invention.

### DESCRIPTION OF THE PREFERRED EMBODIMENT(S)

In the following text, the invention will be explained in more detail in the form of one exemplary embodiment using the drawing, in which the single figure diagrammatically shows the arrangement of the mixing apparatus according to the invention for carrying out the method described.

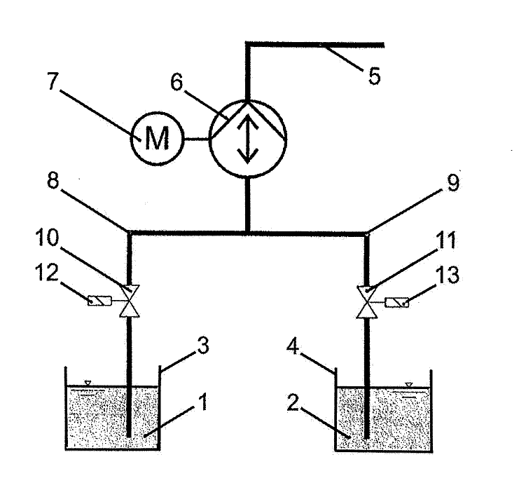

In describing the preferred embodiment of the present invention, reference will be made herein to FIG. 1 of the drawings in which like numerals refer to like features of the invention.

The method according to the invention is based on the concept of carrying out the mixing of the fluids in the pump head of a single oscillating positive displacement pump, the drive of which is controlled in such a way that, in accordance with the proportion of the fluids to be mixed, the suction stroke of the drive is divided over its rotary angle into individual sections, during which the fluids are sucked into the pump head one after another via their suction line, whereupon the fluids which have already been mixed in the pump head are ejected into the conveying line during the subsequent pump delivery stroke.

On account of this procedure, it is ensured in a surprisingly simple way that reliable mixing of the fluids takes place in the single pump head of the oscillating positive displacement pump which is provided, which fluids are then ejected into the conveying line during the delivery stroke of the pump in a form which has already been mixed sufficiently.

There is provision in one refinement according to the invention for the controller of the pump drive to act on valves in the suction lines of the fluids to be mixed, in such a way that, at the beginning of the pump suction stroke, the valve in the suction line of the first fluid is opened and said fluid is sucked into the pump head, whereupon, when the predefined rotary angle is reached, the valve of the first suction line is closed and the valve of the at least one further suction line is opened and the at least one further fluid is sucked into the pump head until the end of the suction stroke.

There is provision in a further refinement of the invention for the division of the rotary angle of the pump drive to be calculated according to the mixing ratio of the fluids. As a result, it is possible in a simple way to set the mixing ratio of the fluids via the drive controller.

When each rotary angle section is reached, the pump drive is expediently stopped for switching over the valves of the suction lines.

With regard to the setting of the mixing ratio of the fluids, the operation is carried out specifically in such a way that it is set via the drive controller.

Finally, it lies within the scope of the invention that the volumetric flow of the fluid mixture is set via the drive speed.

The apparatus which is provided according to the invention for carrying out the method described is configured in such a way that the suction lines of at least two fluids to be mixed, which suction lines are provided with valves, are connected to the pump head of a single oscillating positive displacement pump, the drive controller of which is configured for switching over the valves.

Special advantages result if the drive of the oscillating positive displacement pump is a highly dynamic drive. This is preferably a servomotor, to be precise, in particular, a permanently excited three phase synchronous servomotor.

Similar advantages result if, according to the invention, the oscillating positive displacement pump is a diaphragm pump.

As can be seen from the drawing, two fluids 1, 2 which are provided separately from one another in containers 3, 4 are to be mixed with one another in such a way that, after mixing has been carried out, they are conveyed further in a common conveying line 5.

For this purpose, a single oscillating positive displacement pump 6 is provided which, in the exemplary embodiment shown, is configured as a diaphragm pump. This is provided with a highly dynamic drive 7 including a corresponding controller.

The conveying line 5 which receives the mixed fluids 1, 2 is connected to the delivery side of the pump 6. In contrast, in each case suction lines 8 and 9, which are connected to the fluids 1, 2 and can be opened and closed in each case by valves 10, 11, are connected on the suction side of the pump 6. For this purpose, the valves 10, 11 are provided with corresponding controllers 12, 13 which are connected to the pump drive 7 or its controller.

Here, the pump drive 7 or its controller is configured for switching over the valves 10, 11, to be precise in such a way that, in accordance with the proportion of the fluids 1, 2 to be mixed, the suction stroke of the pump 6 or the pump drive 7 is divided over its rotary angle into individual sections, during which the fluids 1, 2 are sucked into the pump head one after another via their suction lines 8, 9. After this, the fluids 1, 2 which have already been mixed in the pump head are ejected into the conveying line 5 during the subsequent pump delivery stroke.

The controller of the pump drive 7 therefore acts on the valves 10, 11 in the suction lines 8, 9 of the fluids 1, 2 to be mixed, in such a way that, at the beginning of the pump suction stroke, the valve 10 in the suction line 8 of the first fluid 1 is opened, whereupon, when the predefined rotary angle is reached, the valve 10 of the first suction line 8 is closed and the valve 11 of the second suction line 9 is opened and the second fluid 2 is sucked into the pump head until the end of the suction stroke. As already explained, the rotary angle of the pump drive 7 is divided according to the mixing ratio of the fluids 1, 2, which takes place by suitable calculation.

When each rotary angle section is reached, the pump drive 7 is stopped for switching over the valves 10, 11 of the suction lines 8, 9.

It is therefore possible in a simple way to mix two or more fluids in the pump head of a single oscillating positive displacement pump by means of the method described and/or the apparatus described. For this purpose, the suction stroke of the pump drive 7 is divided over the rotary angle according to the proportion of the two fluids 1, 2. Here, the valve 10 for the fluid 1 is opened during the suction stroke of the pump 6 at its front dead center, with the result that said fluid 1 is sucked into the pump head via the suction line 8. When the calculated rotary angle is reached, the pump drive 7 stops, and the valves 10, 11 are switched over, that is to say the valve 10 is closed, whereas the valve 11 is opened. The pump 6 then sucks the fluid 2 via the opened suction line 9 into the pump head during the second section of the suction stroke. At the rear dead center of the suction stroke of the pump 6, the valve 11 is then closed. After the pump drive 7 is restarted, the pump 6 then expels the fluid mixture into the common conveying line 5.

Finally, reference is expressly made to the claims and the drawing with regard to features of the invention which were not explained in detail in the preceding text.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method for mixing at least two fluids separated from one another and subjected to a pump force via a respective suction line, and conveyed into a conveying line by a pump delivery stroke, said method comprising:
controlling a single oscillating positive displacement pump's drive in accordance with a proportion of said at least two fluids to be mixed, including:
dividing said pump's suction stroke of said drive over said pump's rotary angle into individual sections during which said at least two fluids are sucked into said pump head one after another via said respective suction lines;
mixing said at least two fluids in said pump head of said single oscillating positive displacement pump; and
ejecting said mixed fluids into the conveying line during said pump delivery stroke.

2. The method of claim 1, wherein said step of controlling said single oscillating positive displacement pump drive in accordance with a proportion of said at least two fluids to be mixed includes acting on valves in said respective suction lines of said at least two fluids to be mixed, such that at the beginning of said pump suction stroke, a valve in said respective suction line of a first fluid is opened and said first fluid is sucked into said pump head, and whereupon, when a predefined rotary angle is reached, said valve of said respective suction line of said first fluid is closed and a valve of at least one further respective suction line is opened and at least one further fluid is sucked into said pump head.

3. The method of claim 1 including calculating a division of said rotary angle of said pump drive according to a mixing ratio of said at least two fluids.

4. The method of claim 1 including stopping said pump drive for switching over said valves of said respective suctions lines when each of said individual sections of said rotary angle are reached.

5. The method of claim 1 including using a drive controller to mix said at least two fluids.

6. The method of claim 3 including using a drive controller to mix said at least two fluids according to said mixing ratio.

7. The method of claim 1 including setting a volumetric control of said mixed fluids via a drive speed.

8. The method of claim 2 including calculating a division of said rotary angle of said pump drive according to a mixing ratio of said at least two fluids.

9. The method of claim 2 including having said valve of said at least one further respective suction line opened and at least one further fluid sucked into said pump head until the end of said suction stroke.

10. The method of claim 2 including stopping said pump drive for switching over said valves of said respective suctions lines when each of said individual sections of said rotary angle are reached.

11. The method of claim 3 including stopping said pump drive for switching over said valves of said respective suctions lines when each of said individual sections of said rotary angle are reached.

12. A method for mixing fluids, at least two fluids which are separated from one another being sucked in by means of pump force via in each case one suction line and being conveyed into a conveying line by means of a pump delivery stroke, characterized in that the fluids are mixed in the pump head of a single oscillating positive displacement pump, the drive of which is controlled in such a way that, in accordance with the proportion of the fluids to be mixed, the suction stroke of the drive is divided over its rotary angle into individual sections, during which the fluids are sucked into the pump head one after another via their suction line, whereupon the fluids which have already been mixed in the pump head are ejected into the conveying line during the subsequent pump delivery stroke.

13. An apparatus for mixing at least two fluids separated from one another and subjected to a pump force via a respective suction line, and conveyed into a conveying line by a pump delivery stroke, said apparatus comprising:
a single oscillating positive displacement pump;
respective suction lines for each of said at least two fluids to be mixed, said respective suction lines connected to said single oscillating positive displacement pump head;
individual valves for each of said respective suction lines; and
a drive controller configured for switching over said valves.

14. The apparatus of claim 13 wherein the drive of said oscillating positive displacement pump is a highly dynamic drive including a servomotor.

15. The apparatus of claim 14 wherein said drive includes a permanently excited three phase synchronous servomotor.

16. The apparatus of claim 13 wherein said oscillating positive displacement pump comprises a diaphragm pump.
